(19) United States
(12) Patent Application Publication
(10) Pub. No.: US 2004/0057596 A1
(43) Pub. Date: Mar. 25, 2004

(54) Loudspeaker systems

(76) Inventors: Roger J. Green, Warwickshire (GB); David A. Hutchins, Warwickshire (GB)

Correspondence Address: Mark D Saralino, Renner Otto Boisselle & Sklar, 19th Floor, 1621 Euclid Avenue, Cleveland, OH, 44115, US

(21) Appl. No.: 10/433,553

(22) PCT Filed: Dec. 5, 2001
(86) PCT No.: PCT/GB01/05391

(30) Foreign Application Priority Data
Dec. 6, 2000 (GB) 0029755.6

(51) Int. Cl. H04R 1/00; H04R 9/06; H04R 11/02

(52) U.S. Cl. 381/423; 381/431; 381/398

(57) ABSTRACT

A loudspeaker system comprises a flexible paper or plastics diaphragm 1 for displacing a quantity of a transmitting medium to generate sound, waveform-sampling circuitry for supplying a series of sample drive signals of varying amplitude indicative of the amplitudes of an electrical input signal having an audio waveform

This invention relates to loudspeaker systems.

Conventional arrangements for the production of a wide range of sounds from electronic sources include loudspeakers made from a cone of paper or plastics material connected to a cylinder of similar material around which a coil of wire is wound. The cone is moved backwards and forwards by the interaction between the coil and a permanent magnet when an electrical current is passed through the coil. This electrical current is related to the audio signal, which results in the movement of the cone causing acoustic pressure waves to be generated. The relationship between the sound level produced and the electrical current is a complicated one, but is fairly well understood.

One of the characteristics of sound generated in this way is that, it is advantageous to use a large loudspeaker for reproduction of the lower, bass frequencies, whereas it is advantageous to use a small speaker for reproduction of the higher, treble frequencies. For best results, therefore, two or even three loudspeakers are necessary in order to reproduce the full range of audio frequencies. However such a combination of loudspeakers can be quite large, especially when good bass response is required, as in high-fidelity systems. A further feature of such systems is that the spatial distribution of sound is different at the different frequencies, due to the different modes of vibration and different loudspeakers involved in producing a particular sound.

Another conventional arrangement for sound reproduction uses piezoelectric transducers consisting of a piece of piezoelectric material fixed to a diaphragm. The piezoelectric material expands and contracts in sympathy with an applied electrical signal, and this in turn causes deformation of the diaphragm, and hence causes sound waves to be generated. The piezoelectric approach allows a sensitive transducer to be fabricated, but in practice tends to be used for lower quality applications in which a restricted tonal response (frequency response) is acceptable. This technology can also be used for microphones.

A third conventional arrangement for sound reproduction uses a capactative (or electrostatic) loudspeaker in which a diaphragm is attracted towards a fixed surface (which does not deflect) by electrostatic attraction. Such a loudspeaker requires a high voltage to be effective, but can produce a relatively pure sound across a wide range of audio frequencies. Reference is also made to DE 3447111A which is concerned with a sound reproduction arrangement for transmitting audio signals using a conventional loudspeaker, but in which the signals for driving the loudspeaker are obtained by sampling an analogue waveform derived from a digital signal and multiplying the resulting sampling signal by a further sampling waveform. EP 0891117A is concerned with a sound reproduction system in which a digital sound signal is split between sixteen conventional loudspeakers and the resulting sound waves emitted by the loudspeakers are summed to provide the required sound reproduction at the listening position.

In the following description it should be understood that the terms “sound” and “audio” are intended to be interpreted to cover both wavelengths within the normal range of human hearing as produced by conventional sound reproduction systems and ultrasonic wavelengths.

A recent new development in loudspeaker systems makes use of an “HSS” technique in which an ultrasonic beam of sound is used to carry the effect of an audio frequency signal. In this technique, the relatively high power ultrasonic carrier beam utilises the “non-linearity” of the atmosphere to synthesise a range of audio frequencies corresponding to the sound required to be delivered. An advantage of such an ultrasonic carrier technique is that the loudspeaker can be made relatively directional, and a disadvantage of the technique is that there is a requirement for quite high ultrasonic power.

It is an object of the invention to provide a new form of loudspeaker system which is capable of generating sounds over a wide range of frequencies.

According to the present invention there is provided a loudspeaker system comprising diaphragm means (1, 20, 21, 20′, 21′) for displacing a quantity of a transmitting medium to generate sound, waveform-sampling means for supplying a series of sample drive signals of varying amplitude indicative of the amplitudes of an electrical input signal having an audio waveform at a series of sampling points distributed over a period of the waveform, and drive means (4, 23, 25, 23′, 25′) for actuating the diaphragm means (1, 20, 21, 20′, 21′) in response to the drive signals supplied by the waveform-sarnpling means, characterised in that the drive means (4, 23, 25, 23′, 25′) is adapted to actuate the diaphragm means (1, 20, 21, 20′, 21′) at relatively high frequency to generate unipolar pressure pulses in the transmitting medium corresponding to the drive signals by movement of the diaphragm means in only one direction from a rest position, the arrangement being such that the combined acoustic effect of the unipolar pressure pulses in the transmitting medium generated by the series of drive signals is to produce, remotely of the diaphragm means, a synthesised sound wave of relatively low frequency within the transmitting medium mimicking the waveform of the input signal.

Such an arrangement enables, at least in principle, one single transducer to be used for sound reproduction over a wide range of frequencies, with almost equal capability at all audio frequencies, although in many embodiments the loudspeaker system in accordance with the invention will comprise more than one transducer. The principle of operation is based on the idea that a waveform can be synthesised by the combination of closely-spaced sound samples which have substantially equal time characteristics, but have varying amplitude. The time sequence of these samples coalesces to form the synthesised acoustic waveform. Splitting the sound waveform into such samples permits use of a transducer having much higher frequency characteristics than would otherwise be used in such sound reproduction, and accordingly the characteristics of the transducer do not limit the reproduction of low frequency sounds to the same extent as in many conventional arrangements. For this principle to be effective the overall bandwidth of the high frequency transducer should be equal to the required audio bandwidth, in order to ensure that the timed samples join together. The technique can work with only one transducer, using spatial averaging, but with reduced efficiency.

The principle is adapted from well-established communications technologies in which sampled analogue waveforms are used prior to digitisation within analogue-to-digital converters. The concept implies that the ear can utilise and filter the high frequency pressure pulses and interpret them by means of their low frequency envelope. A prototype suggests that the technique can be optimised to realise the perceived benefits. These include: equal treatment of all frequencies within the passband, directionality determined by the acoustic framework for the high frequency utilised as the carrier mechanism, and very small size of the transducer relative to the frequencies of the sound which are perceived to be generated.

In order that the invention may be more fully understood, reference will now be made, by way of example, to the accompanying drawings, in which:

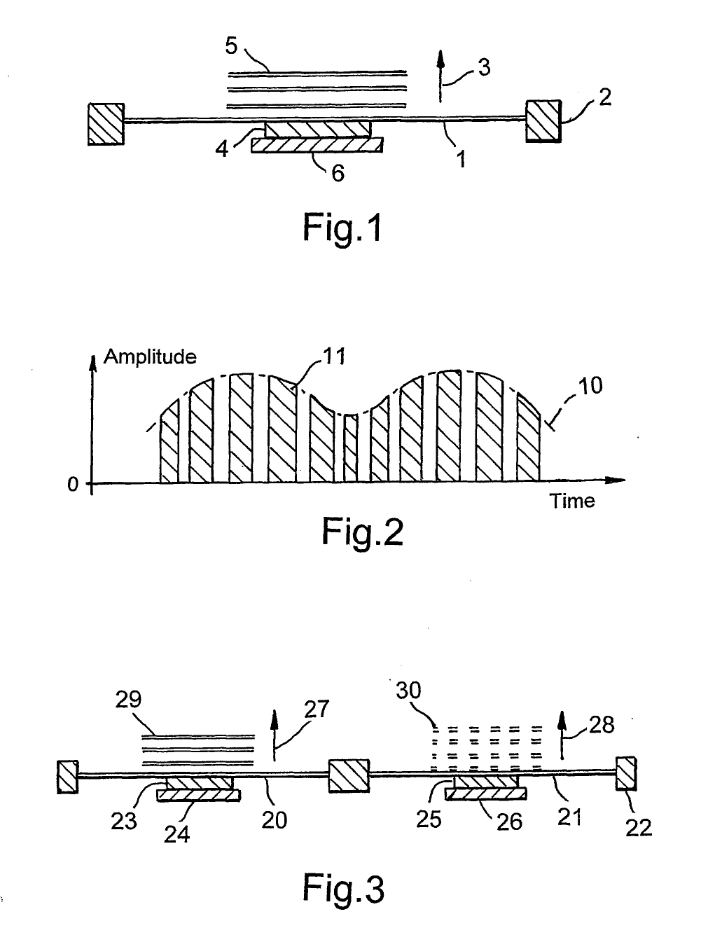

FIG. 1 is a diagram illustrating a single-movement loudspeaker system in accordance with the invention;

FIG. 2 shows a typical driving waveform for driving such a loudspeaker system;

FIG. 3 is a diagram illustrating a dual-movement loudspeaker system in accordance with the invention;

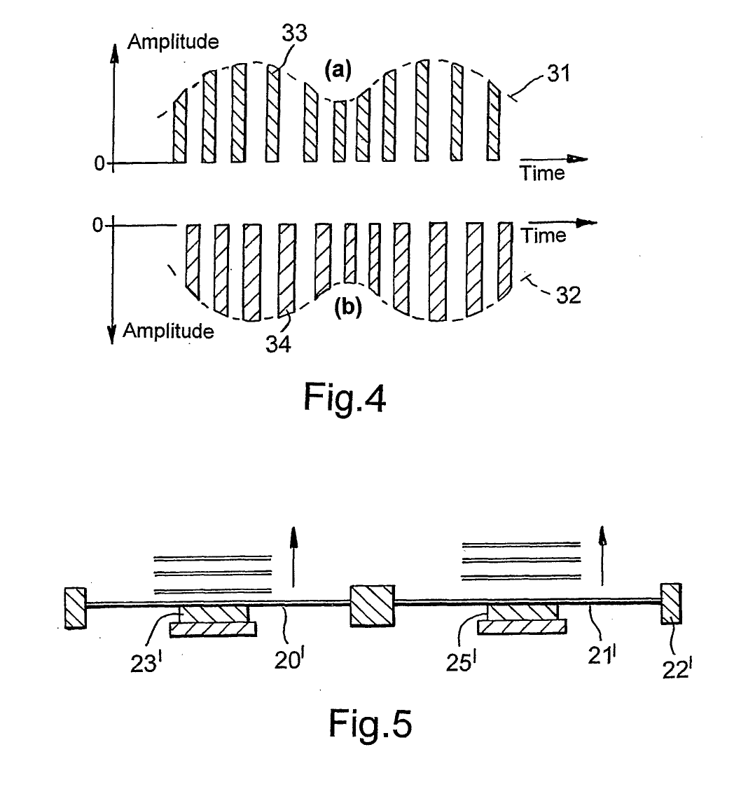

FIG. 4 shows typical driving waveforms for driving such a loudspeaker system;

FIG. 5 is a diagram illustrating an alternative dual-movement loudspeaker system in accordance with the invention;

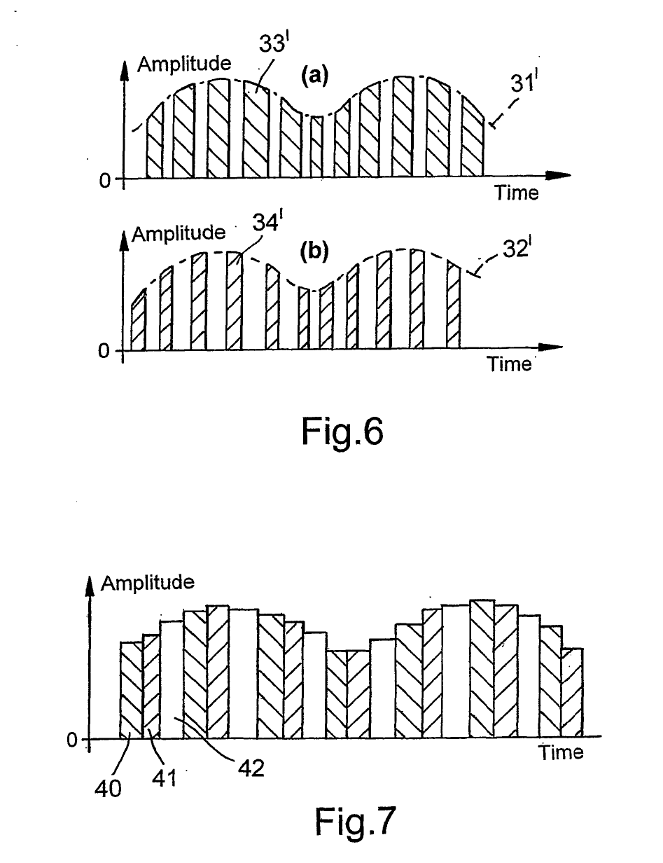

FIG. 6 shows typical driving waveforms for driving such a loudspeaker system;

FIG. 7 shows a typical multiphase waveform for driving an array of loudspeakers in a loudspeaker system in accordance with the invention; and

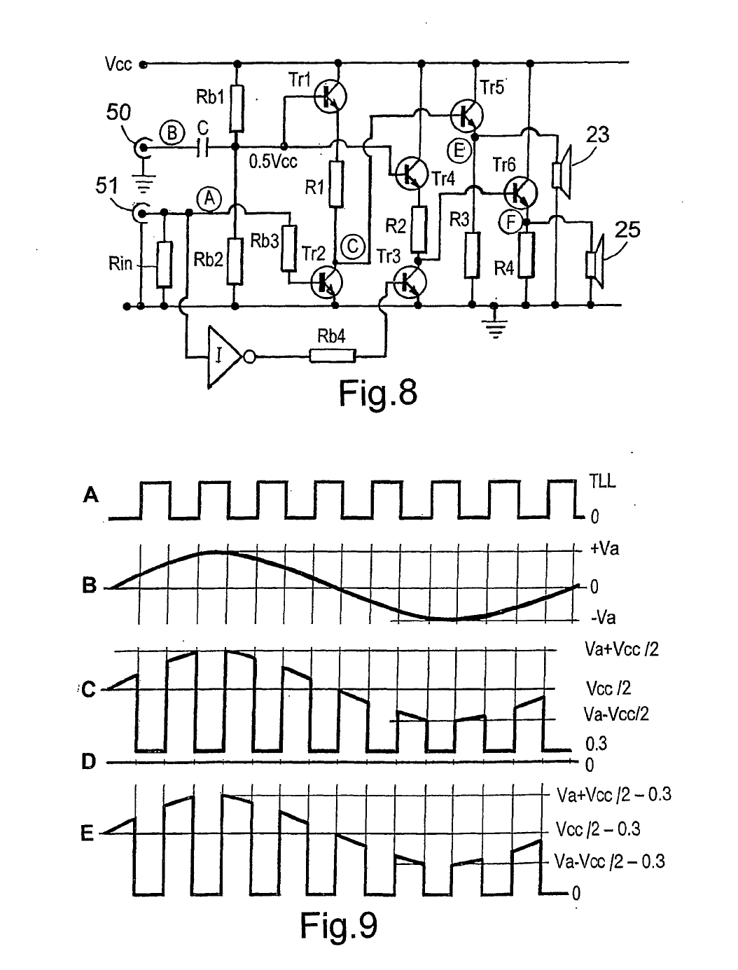

FIG. 8 is a circuit diagram of a possible drive circuit of the loudspeaker system of FIG. 3; and

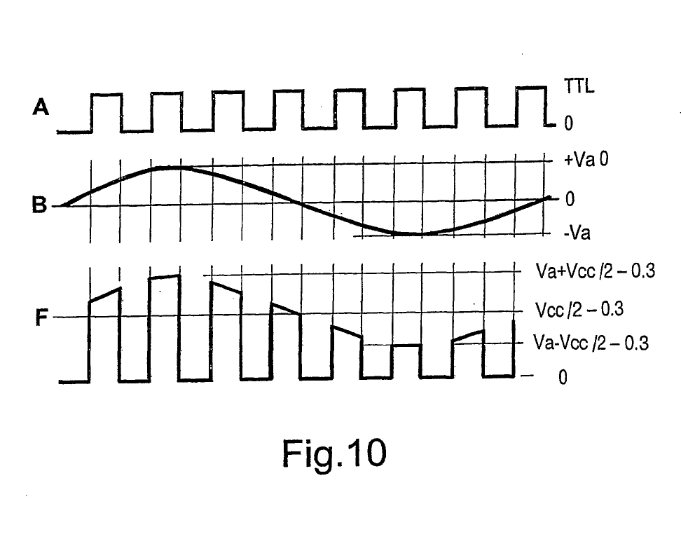

FIGS. 9 and 10 show typical waveforms within the circuit of FIG. 8.

The various embodiments of the invention to be described below utilise waveform-sampling circuitry for sampling an input signal having an audio waveform at a series of points distributed over a period of the waveform so as to supply a series of sample drive signals of varying amplitude to drive circuitry for actuating one or more transducers to cause corresponding displacement of the transmitting medium, which is generally air, such that the combined effect of such displacement by all the drive signals is to produce a synthesised sound wave within the transmitting medium mimicking the waveform of the input signal. Thus the required sound waveform is synthesised by combining closely-spaced sound samples of varying amplitude having substantially equal time characteristics. The overall bandwidth of the high frequency transducer or transducers should be equal to the required audio bandwidth

In the first embodiment shown diagrammatically in FIG. 1 a flexible paper or plastics diaphragm 1 is fixed at its edges within an annular frame 2, and a central portion of the diaphragm 1 is displaceable in a direction normal to the plane of the diaphragm 1, as indicated by the arrow 3, by an actuator 4 on receipt of drive signals in order to produce acoustic pressure waves 5 in the air in front of the diaphragm. The actuator 4 may be a piezoelectric actuator, an electromagnetic actuator, a capacitative actuator or some other form of actuator. The actuator 4 is mounted on a fixed carrier 6 and acts to drive the diaphragm 1 of the transducer in a unipolar mode with the diaphragm 1 being mechanically constrained to move freely in only one direction from the rest position. It is important that the diaphragm 1 of the transducer is constrained to move freely in only one direction since otherwise, in the absence of such constraint, the diaphragm would oscillate around its neutral position when excited, and this would not generate the pressure wavefront required.

This approach requires that the waveform-sampling circuitry samples an input signal having a standard AM (amplitude modulation) driving waveform 10 as shown in the graph of FIG. 2 in a class A configuration, the waveform 10 being sampled at equal intervals over the period of the waveform so as to produce a series of sample drive signals 11 of varying amplitude. The drive signals are supplied to the actuator 4 so as to drive the diaphragm 1 in such a manner as to produce the combined pressure waveform in the air in front of the diaphragm 1. This technique is less efficient with regard to power consumption, but can give a high degree of linearity.

In the second embodiment shown diagrammatically in FIG. 3, the loudspeaker system comprises two flexible paper or plastics diaphragms 20 and 21 fixed at their edges within a composite frame 22, with a central portion of each diaphragm 20, 21 being displaceable in a direction normal to the plane of the diaphragm 20, 21, as indicated by the arrow 27 or 28, by a respective actuator 23 or 25 on receipt of drive signals in order to produce acoustic pressure waves 29 or 30 in the air in front of the diaphragm. As in the first embodiment each actuator 23 or 25 may be a piezoelectric actuator, an electromagnetic actuator, a capacitative actuator or some other form of actuator. Furthermore each actuator 23, 25 is mounted on a fixed carrier 24 or 26 and acts to drive the associated diaphragm 20, 21 with the diaphragm being mechanically constrained to move freely in only one direction from the rest position. However, in this embodiment, the approach requires that one diaphragm is constrained to move freely only forwards (and not backwards) relative to the rest position, whereas the other diaphragm is constrained to move freely only backwards (and not forwards) relative to the rest position.

In this embodiment the waveform-sampling circuitry samples two AM driving waveforms 31 and 32 of opposite polarity as shown in the graphs (a) and (b) of FIG. 4 in a class B configuration, the waveforms 31 and 32 being sampled at equal intervals over the period of the waveform so as to produce two series of sample drive signals 33 and 34 of varying amplitude. The drive signals 33 are supplied to the actuator 23 and the drive signals 34 are supplied to the actuator 25 so as to drive the diaphragms 20, 21 respectively forwardly and backwardly in such a manner as to produce the combined pressure waveform in the air in front of the diaphragms. In this way, a bipolar sampled analogue pressure waveform is generated in front of the diaphragms 20, 21 corresponding to the acoustic equivalent of a class B output stage, which is more power efficient than class A configuration of the embodiment of FIG. 1.

It will be appreciated that, in these embodiments, it is a requirement for the technique to work that the transducer is operated in a unipolar mode, or two transducers are driven by each half of the sampled audio waveform to create the far-field pressure waveform required.

In a third embodiment of the invention as shown in FIG. 5, the loudspeaker system comprises two flexible paper or plastics diaphragms 20′ and 21′ fixed at their edges within a composite frame 22′, with a central portion of each diaphragm 20′, 21′ being displaceable in a direction normal to the plane of the diaphragm 20′, 21′ by a respective actuator 23′ or 25′, in a broadly similar manner to the embodiment of FIG. 3. However, in this embodiment, the waveform-sampling circuitry samples two AM driving waveforms 31′ and 32′ of the same polarity as shown in the graphs (a) and (b) of FIG. 6, the waveforms 31′ and 32′ being sampled alternately and at equal intervals over the period of the waveform so as to produce two series of sample drive signals 33′ and 34′ of varying amplitude. The drive signals 33′ are supplied to the actuator 23′ and the drive signals 34′ are supplied to the actuator 25′ so as to drive the diaphragms 20′, 21′ alternately in such a manner as to produce the combined pressure waveform in the air in front of the diaphragms.

The circuit can be described as an amplitude modulator feeding two transducers in a complementary fashion, so that the phase of the drive signal to one transducer is exactly opposite to the drive signal for the other transducer.

FIG. 8 shows a circuit diagram of a possible drive circuit which may be used in the embodiment of FIG. 3 for generating the required driving waveforms. In this case the Audio waveform to be synthesised at some distance from the actuators 23 and 25 is applied to an audio input 50 at point B in the FIG. 8 by way of a coupling capacitor C of sufficiently low reactance at audio frequencies (for example, 10 μF) in combination with bias resistors Rb1 and Rb2 for two transistors Tr1 and Tr4. The transistors Tr1 and Tr4 act as buffers to the next stage of the circuit, that is they have a nominal gain of unity. The output of the transistor Tr1 is passed by way of a resistor R1 to the base of a transistor Tr5 only when the transistor Tr2 is switched on. Furthermore the transistor Tr2 is switched on and off by a current flowing through a resistor Rb3 produced by a switching waveform (normally at TTL levels or equivalent) applied to a switching waveform input 51. The switching waveform applied across an input resistor Rin to point A is the carrier frequency, chosen so that this frequency lies in the centre of the passband of the actuators at points G and H.

Thus, the audio waveform input at point C is interrupted according to the switching waveform applied to the transistor Tr2 so that, when the transistor Tr2 is off, the output of the transistor Tr1 passes through the resistor R1 to the base of the transistor Tr5, and through the transistor Tr5 by emitter-follower action to the actuator 23 by way of point E. A similar, but complementary action, occurs for the other actuator 25 by way of point F. The switch waveform in this case passes through a digital inverter I and then is applied to the base of the transistor Tr3 through a resistor Rb4. The transistor Tr3 is connected to one end of the resistor R2 to other end of which the emitter of the transistor Tr4 is connected. The transistor Tr4 is supplied with the same waveform as the transistor Trl, that is with the waveform supplied to the audio input 50 at point B. The output of the transistor Tr4 is thus interrupted by the switching action of the transistor Tr3, just as the output of the transistor Tr1 is interrupted by the switching action of the transistor Tr2. The essential difference is that, when the transistor Tr2 is on, the transistor Tr3 is off, and vice versa. Therefore the actuator 23 is active when the actuator 25 is inactive, and vice versa.

This means that alternating pulses of sound are emitted from each actuator 23, 25. By way of further clarification, FIG. 9 shows the waveform at the point E in the circuit diagram of FIG. 8 which is applied to the actuator 23, as well as the waveforms at the points A, B and C in the diagram, and FIG. 10 shows the waveform at the point F in the diagram which is applied to the actuator 25, as well as the waveforms at the points A and B in the diagram. It can be seen that, by comparing the waveforms at points E and F with the switching waveform at the point A, the waveform E is low when the waveform A is high, and at the same time the waveform F is high when the waveform A is high. Conversely, when the waveform A is low, the waveform E is high and the waveform F is low. In each case, the high condition of either the waveform E or the waveform F corresponds to the amplitude of the original audio waveform at the point B at that point in time. This demonstrates the alternate nature of the driving pulses applied to the pair of actuators 23, 25, each actuator dealing with alternate time samples of the original audio waveform at the point B.

The technique permits highly directional or omnidirectional audio loudspeakers to be developed, which are small in size and which can be fabricated using, for example, piezoelectric technology or silicon micromachined technology. The technique could be used to optimise any application in which low frequency information is delivered to a point by a high frequency acoustic carrier, without using the acoustic medium non-linearities as in the HSS approach.

Various other embodiments are possible within the scope of the invention claimed. For example, the technique can also be used with an array of transducers driven by alternate waveforms or by multiphase waveforms, such as the AM driving waveform shown in the graph of FIG. 7 which supplies three sets of drive signals 40, 41 and 42 for driving an array of three transducers.

Since piezoelectric transducers can be prone to distortion at higher signal amplitudes, embodiments utilising multiple transducers, each operating within their linear region, can be particularly advantageous in certain applications. In addition, feedback techniques can be employed to reduce residual distortions in some embodiments.

1. A loudspeaker system comprising diaphragm means (1, 20, 21, 20′, 21′) for displacing a quantity of a transmitting medium to generate sound, waveform-sampling means for supplying a series of sample drive signals of varying amplitude indicative of the amplitudes of an electrical input signal having an audio waveform at a series of sampling points distributed over a period of the waveform, and drive means (4, 23, 25, 23′, 25′) for actuating the diaphragm means (1, 20, 21, 20′, 21′) in response to the drive signals supplied by the waveform-sampling means, characterised in that the drive means (4, 23, 25, 23′, 25′) is adapted to actuate the diaphragm means (1, 20, 21, 20′, 21′) at relatively high frequency to generate unipolar pressure pulses in the transmitting medium corresponding to the drive signals by movement of the diaphragm means in only one direction from a rest position, the arrangement being such that the combined acoustic effect of the unipolar pressure pulses in the transmitting medium generated by the series of drive signals is to produce, remotely of the diaphragm means, a synthesised sound wave of relatively low frequency within the transmitting medium mimicking the waveform of the input signal.

2. A loudspeaker system according to claim 1, wherein the diaphragm means (20, 21, 20′, 21′) comprises a series of separately displaceable diaphragm elements which are displaceable by the drive means (23, 25, 23′, 25′) in response to different drive signals supplied by the waveform-sampling means such that the combined effect of such displacement of all the diaphragm elements is to produce the synthesised sound wave.

3. A loudspeaker system according to claim 1, wherein the diaphragm means (1) comprises a single displaceable diaphragm element which is displaceable by the drive means (4) in response to the drive signals supplied by the waveform-sampling means such that the combined effect of such displacement is to produce the synthesised sound wave.

4. A loudspeaker system according to claim 1, 2 or 3, wherein the diaphragm means (1, 20, 21) comprises a diaphragm constrained to generate the sound by movement in only one direction from a rest position.

5. A loudspeaker system according to claim 4, wherein the waveform-sampling means is arranged to supply the drive signals by sampling of an AM (amplitude modulation) driving waveform (10) supplied by a class A stage.

6. A loudspeaker system according to claim 1, 2 or 3, wherein the diaphragm means (20, 21) comprises a first diaphragm (20) constrained to generate sound by movement in a first direction from a rest position and a second diaphragm (21) constrained to generate sound by movement in a second direction, opposite to the first direction, from the rest position.

7. A loudspeaker system according to claim 6, wherein the waveform-sampling means is arranged to supply the drive signals by sampling of a bipolar AM (amplitude modulation) driving waveform (31, 32) supplied by a class B stage.

8. A loudspeaker system according to claim 1, 2 or 3, wherein the diaphragm means (20′, 21′) comprises a first diaphragm (20′) constrained to generate sound by movement in one direction from a rest position and a second diaphragm (21′) constrained to generate sound by movement in said one direction from the rest position, the drive means (23′, 25) actuating the first and second diaphragms alternately in response to receipt of alternate drive signals supplied by the waveform-sampling means.

9. A loudspeaker system according to claim 1, 2 or 3, wherein the diaphragm means (20, 21, 20′, 21′) comprises an array of diaphragms arranged to be driven by the drive means (23, 25, 23′, 25′) in response to drive signals supplied by sampling of multiphase driving waveforms.

10. A loudspeaker system according to any preceding claim, wherein the diaphragm means (1, 20, 21, 20′, 21′) comprises at least one piezoelectric transducer.

11. A loudspeaker system according to any preceding claim, wherein the diaphragm means (1, 20, 21, 20′, 21′) comprises silicon micromachined technology.

12. A loudspeaker system according to any preceding claim, wherein the waveform-sampling means is adapted to supply drive signals of substantially equal duration by sampling the waveform at a series of points which are substantially equally spaced over the period of the waveform.

13. A loudspeaker system according to any preceding claim, which is an omnidirectional loudspeaker system.

14. A loudspeaker system according to any one of claims 1 to 12, which is a highly directional loudspeaker system.

15. A loudspeaker system according to any preceding claim, wherein the diaphragm means (1, 20, 21, 20′, 21′) is prevented from oscillating about its neutral position to any significant extent.
